(19) United States
(12) Patent Application Publication
(10) Pub. No.: US 2002/0174136 A1
(43) Pub. Date: Nov. 21, 2002

(54) Method and system for high performance transaction processing using a relational database management system

(76) Inventors: Ducan Cameron, Adamstown, MD (US); John Husted, Silverspring, MD (US); Ramakrishnan Jayant, Brookeville, MD (US); Panchapakesan Ramani, Germantown, MD (US); Sridhar Chandrasekharan, Germantown, MD (US)

Correspondence Address: Hughes Electronics Corporation, Patent Docket Administration, Bldg. 1, Mail Stop A1009, P.O. Box 956, El Segundo, CA, 90245-0956, US

(21) Appl. No.: 09/818,723

(22) Filed: Mar. 27, 2001

Related U.S. Application Data
(60) Provisional application No. 60/255,496, filed on Dec. 14, 2000.

(51) Int. Cl. G06F 7/00

(52) U.S. Cl. 707/200

(57) ABSTRACT

An approach for optimizing a database management system is disclosed. A summary table that is used to generate a plurality of tables is stored in a solid state disk. The plurality of tables are stored in the memory of a database server. In addition, a transaction log associated with the plurality of tables are stored on the solid state disk. According to one embodiment of the present invention, this approach is applied to a connection management system in a satellite communication system, wherein the connection management utilizes a relational database to track the communication connections.

### CROSS-REFERENCES TO RELATED APPLICATION

This application is related to, and claims the benefit of the earlier filing date of, U.S. Provisional Patent Application Serial No. 60/255,496, filed December 14, 2000, entitled “Method and System for High Performance Transaction Processing Using a Relational Database Management System,” the entirety of which is incorporated herein by reference.

### BACKGROUND OF THE INVENTION

1. Field of the Invention

The present invention relates generally to data processing, and is more particularly related to enhancing the performance of a database management system.

2. Discussion of the Background

Database management systems (DBMS) play a critical role in all industry segments, from finance to telecommunications. The information infrastructure of these organizations rely heavily on the capability to store and update information rapidly and efficiently, particularly in dynamic applications, such as stock market quotes and trending. Databases have an equally vital part in the management of network operations. Modern telecommunication systems have evolved from a traditional circuit switched model, whereby the communication channels are static, to a more dynamic environment (e.g., virtual circuits in an ATM (Asynchronous Transfer Mode) network, or a packet switched satellite communications network). These communication channels are typically maintained by a network operations center via a DBMS. The establishment and tear-down of these communication channels require a tremendous amount of database transactions to track the dynamic communication channels.

Further, in the event of DBMS failure, recovery of the database can be extremely time consuming, as the system reconstructs the database by performing a large number of transactions. This costly delay may result in the suspension of operations. Given the advances in computing and networking technology, the DBMS has become a source of performance bottleneck; thus, database designers face the challenge of designing a high performance DBMS that is capable of processing large numbers of transactions per second.

FIGS. 6A and 6B are block diagrams of a conventional database management system and associated database tables, respectively, according to an embodiment of the present invention. In a traditional client/server environment, DBMS 600 includes clustered database servers 601 that are connected to a RAID (Redundant Array of Independent Disks) array 603 through a high speed interconnect 605. Interconnect 605 may be a SCSI (Small Computer System Interface) or a fiber channel interface. Clustered database servers 601 include multiple servers that managed as a single node to provide increased system availability, which is a measure of time in which the system is available to service the client stations (not shown). The clustered database servers 601 may run a database application such that each of the servers has an instance of the database; thus, the database is made available to the users even though some of the servers fail.

The RAID array 603 operates on the principle that data transmitted by the clustered servers 601 are stored across a number of disks. RAID specifies a data storage method that distributes data among two or more hard disk drives, utilizing error correction techniques. RAID defines several modes of operation: striping (RAID 0), mirroring (RAID 1), striping plus mirroring (RAID 0/1), and striping with distributed parity (RAID 5). Under RAID 0, the data is interleaved across the multiple disks within the array 603. Mirroring (RAID 1) provides replication of data on multiple disks, thus trading data redundancy at the expense of greater disk space. That is, each drive is a mirror of each of the other drives. RAID 0/1 involves the combination of striping and mirroring. With RAID 5, the data and the parity information are interleaved across multiple disks. The choice of operational mode depends on the application.

Database response time is dictated, in large part, by disk I/O (input/output) bottlenecks. One approach to minimizing response time is to balance the load on the RAID array 603. By placing data files strategically on the physical disks, the likelihood of any one disk becoming stalled during processing of simultaneous I/O requests is reduced. Unfortunately, in practical systems, loading is dynamic, and therefore, achieving perfect load balancing is not possible. In other words, the existence of “hot” disks are inevitable (i.e., disks are that are heavily accessed relative to other disks).

A number of tables 607, 609, 611, 613, and 615, as seen in FIG. 6B, are stored in the RAID array 603. These tables 607, 609, 611, 613, and 615 are typically normalized to eliminate redundant information, thereby reducing the storage requirements. Additionally, normalization provides ease of data maintenance. However, normalization may yield the creation of a large number of tables, which entails a proportionate number of database transactions. Each time any one of the tables 607, 609, 611, 613, and 615 is manipulated (i.e., modified), the DBMS 600 performs the corresponding disk I/O operations.

When transactions are performed, the DBMS 600 maintains a transaction log 619 that is also stored on the RAID array 603; the transaction log 619 captures all the data manipulations (i.e., insert, update, and delete) that occur within each of the tables 607, 609, 611, 613, and 615. Because the DBMS supports a finite number of operations per unit of time, the reduction of these operations results in increased number of transactions that are processed by the DBMS 100. The increased number of transactions negatively impacts database performance.

Based on the foregoing, there is a clear need for improved approaches to maintaining a database management system.

There is also a need to reduce database transaction time.

Based on the need to improve system performance, an approach for providing an optimized database management system is highly desirable.

### SUMMARY OF THE INVENTION

The present invention addresses the above stated needs by providing a technique that utilizes a summary table that is stored on a solid state disk. The summary table is used to reconstruct a number of tables that are then stored within memory. As the data in these tables are manipulated, the corresponding update to the summary table is made. This arrangement can be used in a database management system of a satellite communication system to enhance the performance of managing communication connections.

According to one aspect of the present invention, a method of optimizing performance of a database management system is disclosed. The method includes reconstructing a plurality of tables from a summary table, wherein the summary table containing a summarization of data of the plurality of tables. The method also includes storing the plurality of tables into memory. Further, the method includes selectively manipulating the data within the plurality of tables, and modifying the summary table based upon the manipulating step. Under this arrangement, the number of transactions per second that is performed by the database management system is greatly improved.

In another aspect of the present invention, a database system is disclosed. A processor is configured to reconstruct a plurality of tables from a summary table. The summary table contains a summarization of data of the plurality of tables. A memory is configured to store the plurality of tables. The processor selectively manipulates the data within the plurality of tables, and modifies the summary table in response to the manipulated data.

In another aspect of the present invention, a system is provided for optimizing performance of a database management system. The system includes means for reconstructing a plurality of tables from a summary table. The summary table contains a summarization of data of the plurality of tables. The system also includes means for storing the plurality of tables into memory, and means for selectively manipulating the data within the plurality of tables. The system further includes means for modifying the summary table based the manipulated data.

In yet another aspect of the present invention, a computer-readable medium that carries one or more sequences of one or more instructions for optimizing performance of a database management system is disclosed. The one or more sequences of one or more instructions include instructions which, when executed by one or more processors, cause the one or more processors to perform the step of reconstructing a plurality of tables from a summary table. The summary table contains a summarization of data of the plurality of tables. Another step includes storing the plurality of tables into memory. Other steps include selectively manipulating the data within the plurality of tables, and modifying the summary table based upon the manipulating step.

In yet another aspect of the present invention, a memory for storing information to manage connection resources of a satellite communication system comprises a data structure. The data structure includes a connections records table for storing data relating to capacity allocations of the satellite communication system, and an uplink capacity table for storing data relating to capacity assignments of an uplink of the satellite communications system. Additionally, the data structure includes a downlink capacity table for storing data relating to capacity assignments of a downlink of the satellite communications system, and a connection summary table for storing a summary of the connections records table, the uplink capacity table, and the downlink capacity table. The connection summary table is transferred to a solid state disk for storage. Under the above approach, performance of a database management system is significantly enhanced.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of a database architecture employing a solid state disk, in accordance with an embodiment of the present invention;

FIGS. 2A and 2B are a block diagram of multiple tables stored in memory, wherein a summary table is generated therefrom, and a flowchart of a summarization process, respectively, according to an embodiment of the present invention;

FIG. 3 is a block diagram of a satellite communication system that employs an optimized database management system (DBMS) to provide connection management within a Network Operation Control Center (NOCC), according to an embodiment of the present invention;

FIG. 4 is diagram of exemplary tables that are stored within the memory and within the solid state disk of an optimized DBMS, in accordance with an embodiment of the present invention;

FIG. 5 is a diagram of a computer system that can perform in accordance with an embodiment of the present invention; and

FIGS. 6A and 6B are block diagrams of a conventional database management system and associated tables, respectively, according to an embodiment of the present invention.

### DESCRIPTION OF THE PREFERRED EMBODIMENTS

In the following description, for the purpose of explanation, specific details are set forth in order to provide a thorough understanding of the invention. However, it will be apparent that the invention may be practiced without these specific details. In some instances, well-known structures and devices are depicted in block diagram form in order to avoid unnecessarily obscuring the invention.

The present invention accomplishes improved database performance by utilizing a summary table that is stored on a solid state disk. Upon boot-up of the database, a plurality of tables are reconstructed from the summary table and are stored in memory. In addition, a transaction log that captures the data manipulation of the summary table is stored within the solid state disk.

Although the database optimization technique is described with respect to a connection management system of a satellite communication system, it is recognized by one of ordinary skill in the art that the present invention has applicability to any database management system, in general.

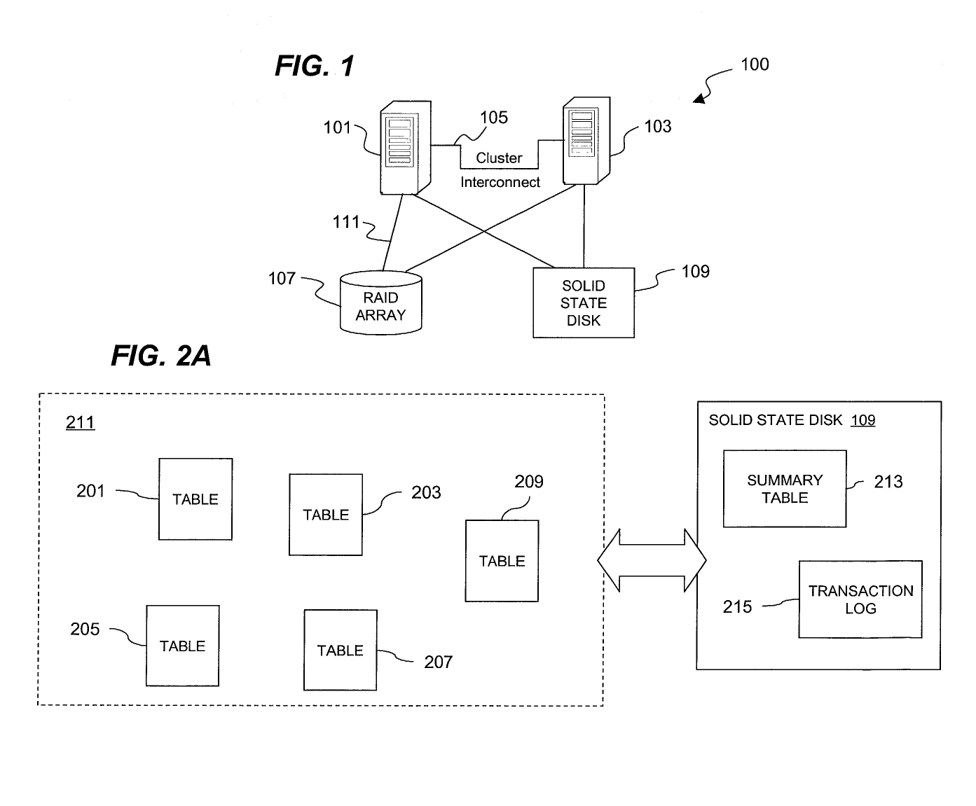

FIG. 1 shows a block diagram of a database architecture employing a solid state disk, in accordance with an embodiment of the present invention. A database management system (DBMS) 100 includes multiple servers 101 and 103 that are clustered through a cluster interconnect 105. The DBMS 100, according to one embodiment of the present invention, is an Oracle database (version 7 or higher), and exists in a client/server environment, whereby the client (not shown) executes a database application that accesses database information that is resident in RAID array 107 and solid state disk 109. Although the discussion of the present invention is made with respect to the Oracle DBMS, it is recognized by one of ordinary skill in the art that any equivalent DBMS may be used (e.g., Sybase DBMS, Informix DBMS, etc.). The servers 101 and 103 execute the Oracle software and support concurrent, shared data access to the database. It should be noted that the Oracle DBMS can be performed on a single computer.

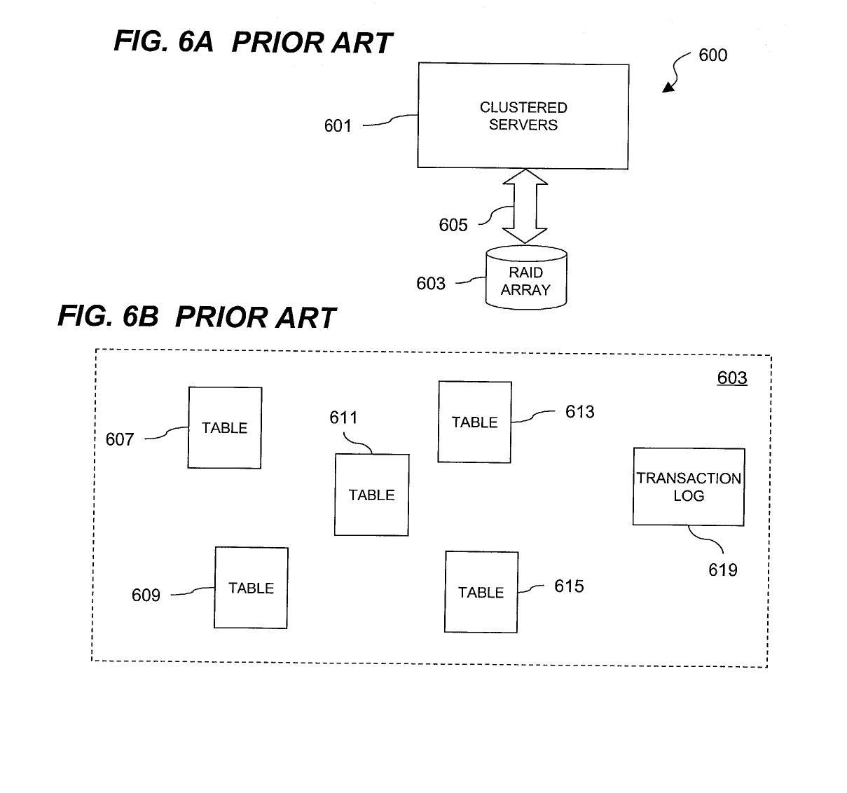

In an exemplary embodiment, each of the servers 101 and 103 are high-end servers. For example, servers 101 and 103 may be Enterprise 10000 servers that are manufactured by Sun Microsystems. The clustered architecture of servers 101 and 103 provide high system availability. Unlike the conventional system of FIG. 6A, the servers 101 and 103 are attached to a RAID array 107 as well as a solid state disk 109 using storage interconnect 111, which, according to an embodiment of the present invention, is a Fiber Channel Arbitrated Loop (FC-AL).

To circumvent disk I/O operations, an instance of the database is placed into memory, as read/write operations in memory are significantly faster than disk read/write operations (by orders of magnitude). The Oracle DBMS 100 allocates a portion of memory of servers 101 and 103 (denoted as the System Global Area (SGA)) and starts one or more Oracle processes. Collectively, the SGA and the Oracle processes are referred to as an Oracle instance. A memory block within the SGA is partitioned as a database buffer cache.

DBMS 100 employs a file caching approach, whereby “hot files”, such as the transaction log, is stored in the solid state disk 109. This advantageously eliminates the mechanical delays of the rotating disk drives of a RAID array, thereby, resulting in significant performance improvements. As discussed earlier, it is well-known that the process of transferring data between disk storage and memory is a performance bottleneck in the operation of a relational database. The transaction log is maintained for every instance of the DBMS 100, wherein data manipulations are recorded so that the database can be recovered in the event of a failure. The transaction log corresponds to a redo log in the Oracle implementation.

The transaction log, essentially, records the “committed” changes to the database tables (e.g., summary 213). When the committed changes are processed, these changes become permanent, and the database is updated accordingly so that the data is made available to all other users of the DBMS 100. Thus, the transaction log preserves the contents of unwritten blocks that have been committed, so that data can be restored if memory loss occurs. Memory failure can result from chip malfunction, operating system failure, or improper shutdown (i.e., instance failure). Consequently, a recovery mechanism is needed to re-execute all the changes associated with the committed transactions.

The transaction log provides this recovery mechanism, permitting the recovery operation to re-execute every command corresponding to the committed changes. In addition, the transaction log contains information to roll back any block changes that were written to disk, but not committed before the occurrence of the memory failure. During a rollback operation, an image of the data prior to the memory failure is applied directly to the data block image where the transaction had effected the change. The rollback operation may be invoked in a variety of circumstances. For instance, the application or user may be physically disconnected from the DBMS 100. Also, the user may issue such a command. Rollback may be necessary as part of the database recovery procedure.

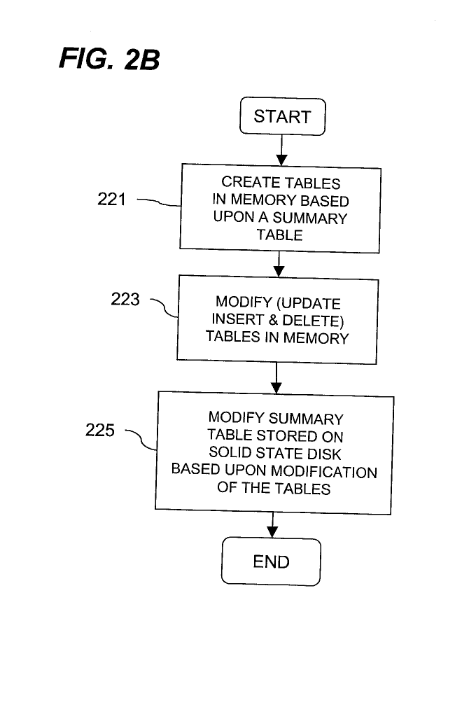

FIGS. 2A and 2B are a block diagram of multiple tables stored in memory, wherein a summary table is generated therefrom, and a flowchart of the process of maintaining the summary table, respectively, according to an embodiment of the present invention. A number of tables 201, 203, 205, 207, and 209 are stored within the memory 211 of clustered servers 103 and 105. These tables 201, 203, 205, 207, and 209 are not stored in the RAID array 107 or the solid state disk 109. The information within these tables 201, 203, 205, 207, and 209 are captured in a summary table 213. In fact, upon start-up, the DBMS 100 creates tables 201, 203, 205, 207, and 209 in memory 211 to avoid manipulating data on the RAID array 107 or the solid state disk 109 (step 221). As mentioned previously, transactions occurring within memory 211 are performed significantly faster than on the RAID array 107.

As the records of the tables 201, 203, 205, 207, and 209 are modified through such operations as update, insert, and delete, per step 223, there exists corresponding transactions within summary table 213. The summary table 213 is modified based upon the modifications of the tables 201, 203, 205, 207, and 209 (step 225); according the transaction log 215 reflects the manipulations in the summary table 213. Because summary table 213 is a single table, the number of data manipulations are reduced. A transaction log 215 tracks the data manipulations of summary table 213. Consequently, a smaller transaction log 215 is produced, thereby yielding performance gains over the conventional approach whereby the transaction log would have to record the manipulations of all the tables 201, 203, 205, 207, and 209. Further, according to an embodiment of the present invention, performance gain is achieved by storing the transaction log 215 on the solid state disk 109. Under the conventional approach, such a transaction file is maintained on the RAID array 107.

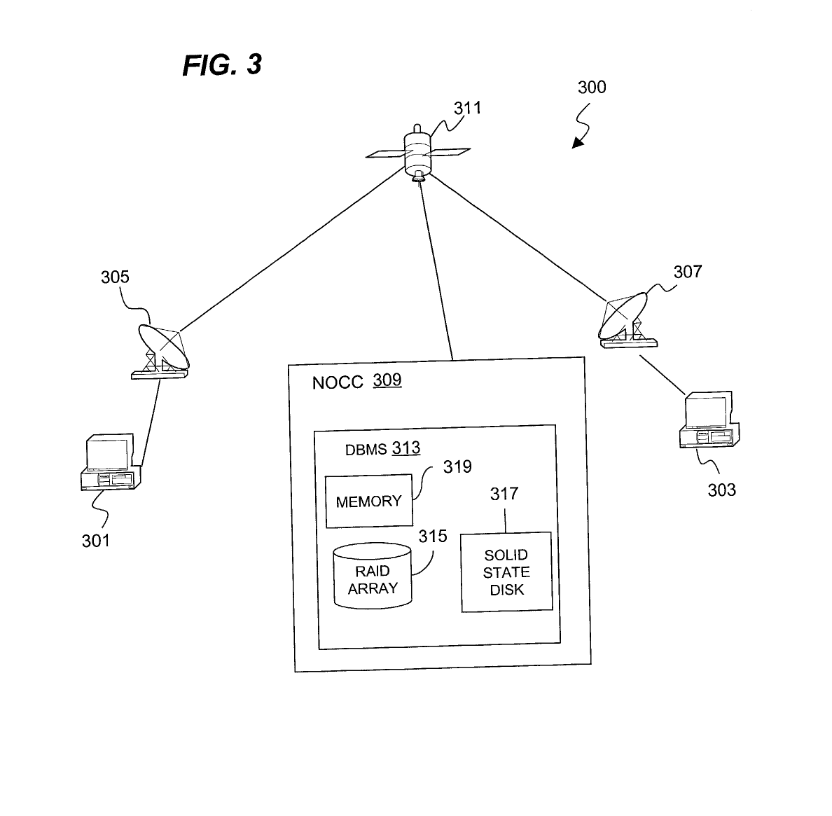

FIG. 3 is a block diagram of a satellite communication system that employs an optimized database management system (DBMS) to provide connection management, according to an embodiment of the present invention. As shown, a satellite system 300 provides connectivity for user host computers 301 and 303, which are attached to satellite terminals (STs) 305 and 307, respectively. Network Operations Control Center (NOCC) (or hub) 309, in conjunction with a payload of satellite 311, provides connection management functions to establish communication channels among the STs 305 and 307 and the NOCC 309. The NOCC 309 manages the system capacity for both uplink channels and downlink channels in the system 300. The NOCC 309 contains a DBMS 313 that utilizes a RAID array 313 and a solid state disk 317. DBMS 313 also uses a memory 319 to store an instance of the database; the memory 319, in an exemplary embodiment, may be the collective memory of a server cluster (as described in FIG. 1). Under this arrangement, the DBMS 313 is optimized to perform connection management functions, as will be more fully described below. To better appreciate the crucial role that DBMS 313 plays in the satellite communication system 300, it is instructive to examine the operation of the system 300, particularly with respect to the establishment of communication channels. 1381 Payload of satellite 311 has a demodulator that demodulates received signals from ST 305, a switch (not shown) that forwards the demodulated signal to an appropriate transponder (not shown), and a modulator that modulates the signal from the switch for transmission over the transponder. The coverage region of system 300 includes numerous uplink cells and downlink cells. A particular cell can be assigned a variable number of demodulators. The amount of uplink capacity in each cell is determined by the number of demodulators that are assigned to the particular cell. According to an exemplary embodiment, a fixed number of demodulators are available for assignment, in which a portion of the demodulators may be assigned to the cells at any given time. Each demodulator provides a predetermined number of channels of capacity. Within the payload, a processor performs such functions as capacity management. Specifically, assignment of demodulators to uplink cells and configuration of demodulator carrier rates are controlled by the NOCC 309.

The system 300 provides a configurable mechanism for allocating network communications resources to meet capacity requirements. According to one embodiment of the present invention, the traffic may be assigned the following priorities (from highest to lowest): connection oriented traffic, high priority connectionless traffic, and low priority connectionless traffic. The system 300 accepts information related to capacity requirements for connection oriented and connectionless services from network service providers (NSPs). Traffic demands in the region can be satisfied dynamically over time by changing resource allocation to the individual cells and STs 305 and 307. The system 300 plans capacity allocations by service class.

The task of assigning frequencies to uplink cells can be viewed as two distinct tasks. First, frequency subbands are allocated to uplink cells, subject to system constraints. Second, physical demodulators are assigned to the cell according to the subband allocation, subject to constraints imposed by the microwave switch matrix on the payload.

Capacity management requires that the NOCC 309 be able to configure the following payload parameters: demodulator assignment to uplink cells, demodulator carrier layout, downlink frame (e.g., a Time Division Multiplexing (TDM) frame) partition, broadcast beam shape, and bandwidth control process parameters. In order for the NOCC 309 to reconfigure capacity over the coverage region, it may be necessary to move several demodulators according to a specific sequence. The payload implements the movement of demodulators, as commanded by the NOCC 309.

Within NOCC 309, the DBMS 313, in one embodiment of the present invention, may include the following capacity management databases: a system capacity resource configuration database, NSP capacity allocations database, downlink service allocations database, and ST service provisions database. The system capacity resource configuration database in DBMS 313 stores the number of demodulators per cell; configuration of each demodulator channel rates; allocation of channels to scheduled services, on-demand services, connectionless services, and overhead; allocation of fixed contention channels, engineering channels, and blocked channels; and point-to-point versus duty cycle. The NSP capacity allocations database in DBMS 313 supports a number of NSPs, and stores uplink service allocations per NSP and ST for each of the following services: scheduled, on-demand, and connectionless. The NOCC 309 also maintains a downlink service allocations database in DBMS 313 for broadcast, multicast, and point-to-point services. Further, the NOCC 309 has an ST service provisions database in DBMS 313 for storing the ST profiles.

The NOCC 309 is responsible for managing connection-oriented traffic such that the capacity allocated to an NSP is available for use by the NSP's STs 305 and 307 and that the STs 305 and 307 owned by an NSP receive the services they are provisioned. To manage the system capacity, the NOCC 309 needs to know how much capacity is available, how much is allocated to each NSP, and the mapping of STs 305 and 307 to NSPs. The NOCC 309 keeps track of how much capacity is currently being used by each NSP's STs. The connection admission control gates, which are checked by NOCC 309 when a connection request is received from an ST, may include ST level restrictions (NSP specified), ST level restrictions (uplink/downlink cell capacity, multicast, broadcast, point-to-point (PTP)), NSP level restrictions (uplink/downlink cell capacity, multicast, broadcast, PTP), uplink and downlink availability, and future scheduled connections' effect on downlink availability. It should be noted that scheduled connections have priority over on-demand connections.

On-demand connection setup requests received by the NOCC 309 shall be recorded along with a status (granted/denied). If a connection is denied then a reason for denial shall also be recorded; e.g., NSP allocation has been exceeded, or capacity is not available.

The NOCC 309 is responsible for managing connection-oriented downlink capacity, where the downlink traffic destination is known at connection setup time. As stated earlier, the payload manages the broadcast downlink capacity to ensure that the broadcast beams do not become congested due to overallocation of high priority connectionless service.

The following table shows the possible types of services that can be allocated to an NSP. All service types can be allocated to NSPs and managed at the NSP level, at any of the configurable rates. In an exemplary embodiment, connectionless traffic may not be multicast.

TABLE 1

| | |
|---|---|
| Connection Oriented | Connectionless |

| Uplink | | On | High | Low |
|---|---|---|---|---|
| Downlink | Schedule | Demand | Priority | Priority |
| Broadcast | Yes | Yes | Yes | No |
| Multicast | Yes | Yes | No | No |
| Point-to-Point | Yes | Yes | Yes | Yes |

On-demand connection-oriented capacity is allocated to an NSP in each uplink cell which the NSP has subscribed. Configurable amounts of dedicated and shared capacity are allocated to each NSP from the on-demand pool of capacity in the cell. The NOCC 309 manages an NSP's capacity allocations in each uplink cell independent of the NSP's allocations in other cells.

Connectionless service in the system 300 is defined as follows. In such a service, data can be transmitted by an ST without prior path setup—in contrast to connection-oriented traffic, which must pass connection management procedures at the NOCC 309 prior to being allowed on the system 300. Depending on the service, STs 305 and 307 may initiate connectionless bandwidth requests directly to the payload without the request being granted by the NOCC 309.

Furthermore, the payload may execute a bandwidth-on-demand (BOD) process that allocates connectionless bandwidth to STs 305 and 307. With respect to managing connectionless service, the NOCC 309 limits the number of connections granted in each uplink cell so that the connection-oriented allocations made by the BOD process do not affect the connectionless capacity pool. The amount of connectionless service on the broadcast beam is specified and managed so the broadcast beam does become congested by too many connectionless service allocations. One way to managing this service is to limit the service strictly to high priority connectionless, in which the bandwidth requests specify the downlink destinations. Thus, the BOD process manages the broadcast beam based on the TDM frame partition, connection-oriented service on the broadcast beam, and number of connectionless service requests queued for the broadcast beam. The BOD function limits the connectionless bandwidth allocations that are made in each frame to a NOCC 309 specified limit.

To initiate communication, the ST 305 sends connection requests (i.e., bandwidth allocation requests) to the NOCC 309; the ST 305 may also forward traffic measurements/statistics to the NOCC 309 to assist the NOCC 309 with management of the system capacity. To manage system capacity efficiently and effectively, the NOCC 309 maintains the three categories of information in one or more capacity management databases within DBMS 313, which, in an exemplary embodiment, is locally situated within the NOCC 309. If the NOCC 309 were required to access information from an NSP in order to make decisions related to capacity, system performance would be negatively impacted.

The capacity resource configuration database in DBMS 313 specifies when information about new capacity allocations is formatted and provided to the satellite 105 as frequency plans and to the NOCC 309. The NSP capacity allocations database in DBMS 313 store NSP capacity allocation parameters for each of the NSPs. The ST service allocations database in DBMS 313 house the ST profiles.

The NSP selectively supplies the NOCC 309 with various service parameters. The NSP specifies whether the ST 305 and 307 is allowed to make on-demand connections, the rate and priority at which such connections are allowed, and the downlink destinations. It should be noted that scheduled and on-demand connection priorities that are specified by an NSP are relative to the STs 305 and 307 that are owned by the NSP, and are independent of priorities specified by other NSPs. In addition, the NSP specifies whether the ST 305 and 307 is allowed to use connectionless services, including carrier rate and priority. If the ST is provided with multicasting capability, the NSP specifies rate and multicast group information. The NSP may also indicate whether the ST subscribes to on-demand broadcast and/or connectionless broadcast service, in which case, NSP specifies the rates, the broadcast beam(s) that the ST is allowed to send traffic on, and the beam that the ST is to listen to for broadcasts. Further, the NSP specifies whether the ST is allowed to send user traffic on the contention channels. ST type and location are somewhat static in that they typically will not change over time for a given end user. The other parameters, however, may change over time; and it is the responsibility of the NOCC 309 to monitor such changes and to ensure that all ST service provisions are within the scope of the NSP's capacity provisions.

As evident from the above description, DBMS 313 is required to store a vast quantity of data relating to proper connection management processing within the satellite communication system 300. Accordingly, the DBMS 313 is required to deliver high performance to track the dynamic connection establishments and terminations on a real-time basis.

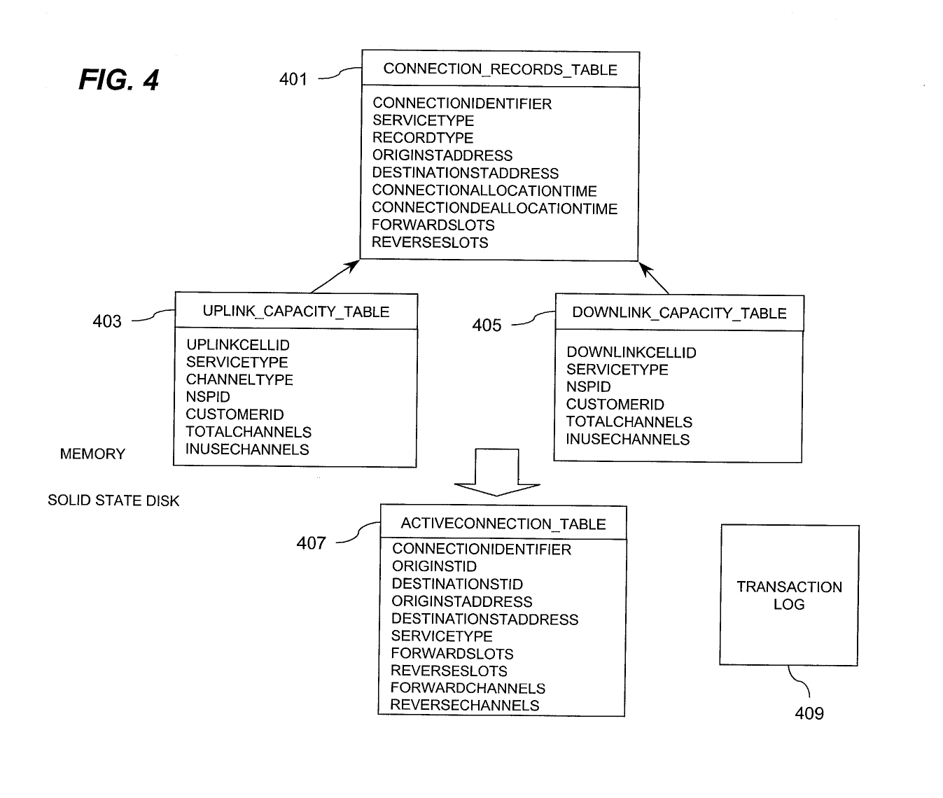

FIG. 4 is a diagram of exemplary tables that are stored within memory and within the solid state disk, in accordance with an embodiment of the present invention. To manage the connection resources, the database management system 300 within NOCC 309 employs the following tables: a CONNECTION_RECORDS_TABLE 401, a UPLINK_CAPACITY_TABLE 403, a DOWNLINK_CAPACITY_TABLE 405, and an ACTIVECONNECTION_TABLE 407. ACTIVECONNECTION_TABLE 407 serves as the summary table for the CONNECTION_RECORDS_TABLE 401, the UPLINK_CAPACITY_TABLE 403, and the DOWNLINK_CAPACITY_TABLE 405. ACTIVECONNECTION_TABLE 407 stores data relating to the active connections within the satellite system 300, and contains the following fields: a CONNECTIONIDENTIFIER field for uniquely identifying the particular connection, an ORIGINSTID field for specifying the ST that initiates the establishment of the communication channel, a DESTINATIONSTID field for specifying the destination ST, an ORIGINSTADDRESS field for storing the address (e.g., IP address) of the originating ST, a DESTINATIONSTADDRESS field for storing the address (e.g., IP address) of the destination ST, a SERVICETYPE field for specifying the user service, a FORWARDSLOTS field for indicating the frame slots that are used in forward direction, a REVERSESLOTS field for indicating the frame slots that are used in the reverse direction, a FORWARDCHANNELS field for specifying the channels that are used in the forward direction, and a REVERSECHANNELS field for specifying the channels that are used in the reverse direction.

The CONNECTION_RECORDS_TABLE 401 stores data relating to the capacity allocations within the system 300. Within table 401, a CONNECTIONIDENTIER field is provided to uniquely identify the particular connection. Table 401 also includes the following fields: a SERVICETYPE field for specifying the user service, a RECORDTYPE field for storing the record type, an ORIGINSTADDRESS field for storing the source address, a DESTINATIONSTADDRESS field for storing the destination address, a CONNECTIONALLOCATIONTIME field for storing the allocation time, a CONNECTIONDEALLOCATIONTIME field for storing the deallocation time, a FORWARDSLOTS field for indicating the frame slots that are used in forward direction, and a REVERSESLOTS field for indicating the frame slots that are used in the reverse direction.

The UPLINK_CAPACITY_TABLE 403 stores data relating to the capacity assignment of the uplink. Table 403 includes the following fields: an UPLINKCELLID field for storing the uplink cell identification, a SERVICETYPE field for specifying the user service, a CHANNELTYPE field for indicating the type of channel that is used, an NSPID field for specifying the identification of the network service provider associated with the allocation, a CUSTOMERID field for storing identification of the customer of the NSP, a TOTALCHANNELS field for storing the total number of channels, an INUSECHANNELS field for specifying the number of channels that are in use.

As with the UPLINK_CAPACITY_TABLE 403, the DOWNLINK_CAPACITY_TABLE 405 contains information relating to the capacity allocation of the downlink of the system 300. Table 405 has a DOWNLINKCELLID field for specifying the cell ID of the downlink. The other fields of table 405 are similar to that of the UPLINK_CAPACITY_TABLE 403 and include the following: a SERVICETYPE field for specifying the user service, a CHANNELTYPE field for indicating the type of channel that is used, an NSPID field for specifying the identification of the network service provider associated with the allocation, a CUSTOMERID field for storing identification of the customer of the NSP, a TOTALCHANNELS field for storing the total number of channels, an INUSECHANNELS field for specifying the number of channels that are in use.

Upon start-up, DBMS 313 constructs the CONNECTION_RECORDS_TABLE 401, the UPLINK_CAPACITY_TABLE 403, and the DOWNLINK_CAPACITY_TABLE 405 based upon the ACTIVECONNECTION_TABLE 407. The ACTIVECONNECTION_TABLE 407 is stored in the solid state disk 317, whereas tables 401, 403, and 405 strictly reside within memory 407. The DBMS 313 also stores a transaction log 409 on the solid state disk 317.

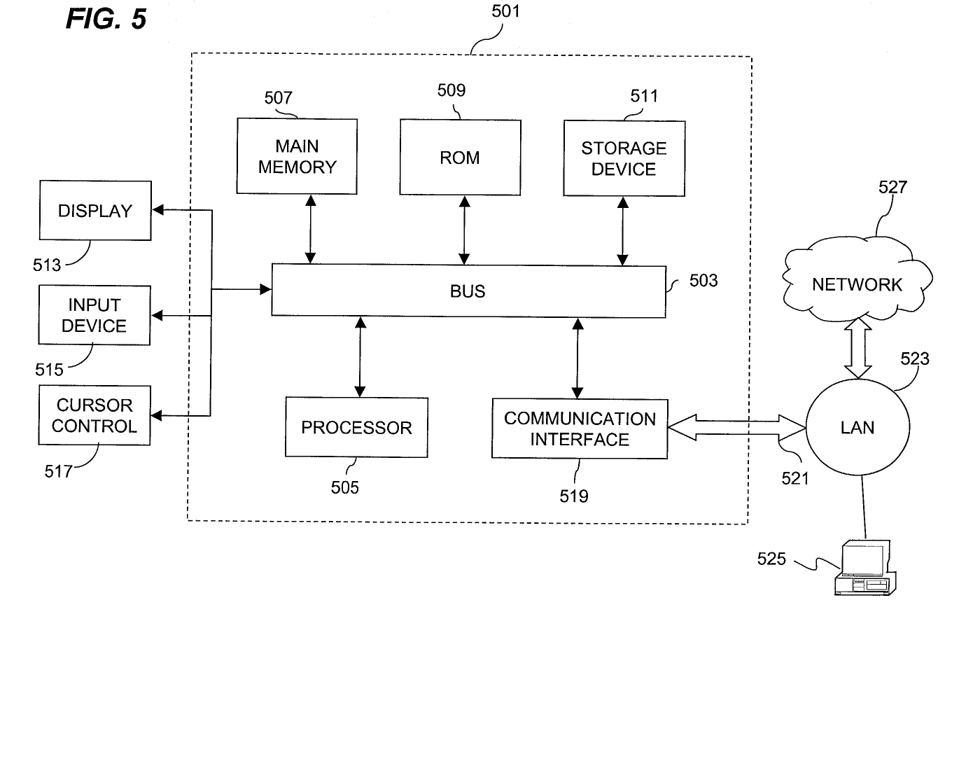

FIG. 5 illustrates a computer system 501 upon which an embodiment according to the present invention may be implemented to manage the system capacity of system 300. Computer system 501 includes a bus 503 or other communication mechanism for communicating information, and a processor 505 coupled with bus 503 for processing the information. Computer system 501 also includes a main memory 507, such as a random access memory (RAM) or other dynamic storage device, coupled to bus 503 for storing information and instructions to be executed by processor 505. In addition, main memory 507 may be used for storing temporary variables or other intermediate information during execution of instructions to be executed by processor 505. Computer system 501 further includes a read only memory (ROM) 509 or other static storage device coupled to bus 503 for storing static information and instructions for processor 505. A storage device 511, such as a magnetic disk or optical disk, is provided and coupled to bus 503 for storing information and instructions.

Computer system 501 may be coupled via bus 503 to a display 513, such as a cathode ray tube (CRT), for displaying information to a computer user. An input device 515, including alphanumeric and other keys, is coupled to bus 503 for communicating information and command selections to processor 505. Another type of user input device is cursor control 517, such as a mouse, a trackball, or cursor direction keys for communicating direction information and command selections to processor 505 and for controlling cursor movement on display 513.

According to one embodiment, the data manipulation of DBMS 300 and creation of the transactions log 409 is provided by computer system 501 in response to processor 505 executing one or more sequences of one or more instructions contained in main memory 507. Such instructions may be read into main memory 507 from another computer-readable medium, such as storage device 511. Execution of the sequences of instructions contained in main memory 507 causes processor 505 to perform the process steps described herein. One or more processors in a multi-processing arrangement may also be employed to execute the sequences of instructions contained in main memory 507. In alternative embodiments, hard-wired circuitry may be used in place of or in combination with software instructions. Thus, embodiments are not limited to any specific combination of hardware circuitry and software.

Further, the instructions to manipulate the tables 201, 203, 205, 207, and 209 may reside on a computer-readable medium. The term “computer-readable medium” as used herein refers to any medium that participates in providing instructions to processor 505 for execution. Such a medium may take many forms, including but not limited to, non-volatile media, volatile media, and transmission media. Non-volatile media includes, for example, optical or magnetic disks, such as storage device 511. Volatile media includes dynamic memory, such as main memory 507. Transmission media includes coaxial cables, copper wire and fiber optics, including the wires that comprise bus 503. Transmission media can also take the form of acoustic or light waves, such as those generated during radio wave and infrared data communication.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 505 for execution. For example, the instructions may initially be carried on a magnetic disk of a remote computer. The remote computer can load the instructions relating to data manipulation of DBMS 300 remotely into its dynamic memory and send the instructions over a telephone line using a modem. A modem local to computer system 501 can receive the data on the telephone line and use an infrared transmitter to convert the data to an infrared signal. An infrared detector coupled to bus 503 can receive the data carried in the infrared signal and place the data on bus 503. Bus 503 carries the data to main memory 507, from which processor 505 retrieves and executes the instructions. The instructions received by main memory 507 may optionally be stored on storage device 511 either before or after execution by processor 505.

Computer system 501 also includes a communication interface 519 coupled to bus 503. Communication interface 519 provides a two-way data communication coupling to a network link 521 that is connected to a local network 523. For example, communication interface 519 may be a network interface card to attach to any packet switched local area network (LAN). As another example, communication interface 519 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 519 sends and receives electrical, electromagnetic or optical signals that carry digital data streams representing various types of information.

Network link 521 typically provides data communication through one or more networks to other data devices. For example, network link 521 may provide a connection through local network 523 to a host computer 525 or to data equipment operated by a service provider, which provides data communication services through a communication network 527 (e.g., the Internet). LAN 523 and network 527 both use electrical, electromagnetic or optical signals that carry digital data streams. The signals through the various networks and the signals on network link 521 and through communication interface 519, which carry the digital data to and from computer system 501, are exemplary forms of carrier waves transporting the information. Computer system 501 can transmit notifications and receive data, including program code, through the network(s), network link 521 and communication interface 519.

The techniques described herein provide several advantages over prior approaches to optimizing a database management system. A plurality of tables are constructed from a summary table, wherein the summary table is stored on a solid state disk. The constructed tables are stored in memory. Further, a transaction log corresponding to the summary table is stored on the solid state disk. Under this approach, the DBMS performance is enhanced.

Obviously, numerous modifications and variations of the present invention are possible in light of the above teachings. It is therefore to be understood that within the scope of the appended claims, the invention may be practiced otherwise than as specifically described herein.

What is claimed is:

1. A method of optimizing performance of a database management system, the method comprising:
reconstructing a plurality of tables from a summary table, the summary table containing a summarization of data of the plurality of tables;
storing the plurality of tables into memory;
selectively manipulating the data within the plurality of tables; and
modifying the summary table based upon the manipulating step.

2. The method of claim 1, wherein the summary table in the reconstructing step is stored on a solid state disk.

3. The method of claim 1, further comprising:
updating a transaction log that records modifications to the summary table, the transaction log being stored on a solid state disk.

4. The method of claim 1, wherein the data of the plurality of tables include communication connection information of a satellite communication system.

5. The method of claim 1, further comprising:
storing a portion of the plurality of tables in a RAID (Redundant Array of Independent Disks) array.

6. A database system, comprising:
a processor configured to reconstruct a plurality of tables from a summary table, the summary table containing a summarization of data of the plurality of tables; and
a memory configured to store the plurality of tables,
wherein the processor selectively manipulates the data within the plurality of tables, and modifies the summary table in response to the manipulated data.

7. The system of claim 6, further comprising:
a solid state disk configured to store the summary table.

8. The system of claim 7, wherein the processor updates a transaction log that records modifications to the summary table, the transaction log being stored on a solid state disk.

9. The system of claim 6, wherein the data of the plurality of tables include communication connection information of a satellite communication system.

10. The system of claim 6, further comprising:
a RAID (Redundant Array of Independent Disks) array configured to store a portion of the plurality of tables.

11. A system for optimizing performance of a database management system, the system comprising:
means for reconstructing a plurality of tables from a summary table, the summary table containing a summarization of data of the plurality of tables;
means for storing the plurality of tables into memory;
means for selectively manipulating the data within the plurality of tables; and
means for modifying the summary table based upon the manipulated data.

12. The system of claim 11, wherein the summary table is stored on a solid state disk.

13. The system of claim 11, further comprising:
means for updating a transaction log that records modifications to the summary table, the transaction log being stored on a solid state disk.

14. The system of claim 11, wherein the data of the plurality of tables include communication connection information of a satellite communication system.

15. The system of claim 11, further comprising:
means for storing a portion of the plurality of tables in a RAID (Redundant Array of Independent Disks) array.

16. A computer-readable medium carrying one or more sequences of one or more instructions for optimizing performance of a database management system, the one or more sequences of one or more instructions including instructions which, when executed by one or more processors, cause the one or more processors to perform the steps of:
reconstructing a plurality of tables from a summary table, the summary table containing a summarization of data of the plurality of tables;
storing the plurality of tables into memory;
selectively manipulating the data within the plurality of tables; and
modifying the summary table based upon the manipulating step.

17. The computer-readable medium of claim 16, wherein the summary table in the reconstructing step is stored on a solid state disk.

18. The computer-readable medium of claim 16, further comprising computer-executable instructions for causing the one or more processors to perform the step of:
updating a transaction log that records modifications to the summary table, the transaction log being stored on a solid state disk.

19. The computer-readable medium of claim 16, wherein the data of the plurality of tables include communication connection information of a satellite communication system.

20. The computer-readable medium of claim 16, further comprising computer-executable instructions for causing the one or more processors to perform the step of:
storing a portion of the plurality of tables in a RAID (Redundant Array of Independent Disks) array.

21. A memory for storing information to manage connection resources of a satellite communication system, comprising a data structure including:
a connections records table for storing data relating to capacity allocations of the satellite communication system;
an uplink capacity table for storing data relating to capacity assignments of an uplink of the satellite communications system;
a downlink capacity table for storing data relating to capacity assignments of a downlink of the satellite communications system; and
a connection summary table for storing a summary of the connections records table, the uplink capacity table, and the downlink capacity table, wherein the connection summary table is transferred to a solid state disk for storage.

22. The memory of claim 21, wherein the connections records table comprises:
a connection identifier field for identifying a connection among a plurality of connections in the satellite communication system;
a service type field for specifying user service;
a record type field for specifying type of record;
an origin address field for storing a source address of a satellite terminal that generates data to be transmitted over the satellite communication system;
a destination address field for storing a destination address of a satellite terminal that is to receive the data;
an allocation time field for storing allocation time of the connection;
a deallocation time field for storing deallocation time of the connection;
a forward slots field for indicating frame slots associated with the plurality of connections in a forward direction; and
a reverse slots field for indicating frame slots associated with the plurality of connections in a reverse direction.

23. The memory of claim 21, wherein the uplink capacity table comprises:
an uplink cell identifier field for storing an uplink cell identification of the satellite communication system;
a service type field for specifying user service;
a channel type field for indicating channel type of a connection among a plurality of connections;
a service provider identifier field for identifying a service provider associated with at least one of the capacity assignments;
a channels field for storing the number of the plurality of connections; and
an inuse channels field for storing the number of connections that are in use.

24. The memory of claim 21, wherein the downlink capacity table comprises:
an downlink cell identifier field for storing a downlink cell identification of the satellite communication system;
a service type field for specifying user service;
a channel type field for indicating channel type of a connection among a plurality of connections;
a service provider identifier field for identifying a service provider associated with at least one of the capacity assignments;
a channels field for storing the number of the plurality of connections; and
an inuse channels field for storing the number of connections that are in use.

25. The memory of claim 21, wherein the connection summary table comprises:
a connection identifier field for identifying a connection among a plurality of connections in the satellite communication system;
an origin identifier field for specifying a satellite terminate that initiates establishment of the connection;
a destination identifier field for specifying a satellite terminate that terminates the established connection;
an origin address field for storing a source address of the satellite terminate that initiates establishment of the connection;
a destination address field for storing a destination address of the satellite terminate that terminates the established connection;
a service type field for specifying user service;
a forward slots field for indicating frame slots associated with the plurality of connections in a forward direction;
a reverse slots field for indicating frame slots associated with the plurality of connections in a reverse direction;
a forward channels field for indicating the plurality of connections in the forward direction; and
a reverse slots field for indicating the plurality of connections in the reverse direction.
